(19) United States
(12) Patent Application Publication
(10) Pub. No.: US 2026/0172818 A1
(43) Pub. Date: Jun. 18, 2026

(54) RECEPTION MODE ADAPTATION FOR MULTI RECEIVER CHAIN CAPABLE DEVICES

(71) Applicant: Nokia Technologies Oy, Espoo (FI)

(72) Inventors: Rafael CAUDURO DIAS DE PAIVA, Aalborg (DK); Lars DALSGAARD, Oulu (FI); Samantha CAPORAL DEL BARRIO, Aalborg (DK); Daejung YOON, Nozay (FR)

(21) Appl. No.: 19/100,017

(22) PCT Filed: Jul. 28, 2023
(86) PCT No.: PCT/EP2023/070944

§ 371 Date: Jan. 30, 2025

Related U.S. Application Data
(60) Provisional application No. 63/396,711, filed on Aug. 10, 2022.

(51) Int. Cl. H04W 8/24; H04W 72/23

(52) U.S. Cl. CPC H04W 8/24; H04W 72/23

(57) ABSTRACT

Systems, methods, apparatuses, and computer program products for multi-reception chain UEs. One method may include receiving, from a serving cell, at least one radio resource control configuration or device capability report signal associated with at least one multi-reception chain user equipment mode; transmitting, to the serving cell, an indication that at least one multi-reception chain user equipment mode is preferred; and in response to transmitting the indication that at least one multi-reception chain user equipment mode is preferred, receiving, from the serving cell, an indication that the at least one preferred multi-reception chain user equipment mode is in operation.

### TECHNICAL FIELD

Some example embodiments may generally relate to mobile or wireless telecommunication systems, such as Long Term Evolution (LTE), fifth generation (5G) radio access technology (RAT), new radio (NR) access technology, sixth generation (6G), and/or other communications systems. For example, certain example embodiments may relate to systems and/or methods for multi-reception (Rx) chain UEs.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the RAN for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include receiving, from a serving cell, at least one radio resource control configuration or device capability report signal associated with at least one multi-reception chain user equipment mode. The method may further include transmitting, to the serving cell, an indication that at least one multi-reception chain user equipment mode is preferred. The method may further include, in response to transmitting the indication that at least one multi-reception chain user equipment mode is preferred, receiving, from the serving cell, an indication that the at least one preferred multi-reception chain user equipment mode is in operation.

In accordance with certain example embodiments, an apparatus may include means for receiving, from a serving cell, at least one radio resource control configuration or device capability report signal associated with at least one multi-reception chain user equipment mode. The apparatus may further include means for transmitting, to the serving cell, an indication that at least one multi-reception chain user equipment mode is preferred. The apparatus may further include means for, in response to transmitting the indication that at least one multi-reception chain user equipment mode is preferred, receiving, from the serving cell, an indication that the at least one preferred multi-reception chain user equipment mode is in operation.

In accordance with various example embodiments, a non-transitory computer readable medium comprising program instructions that, when executed by an apparatus, cause the apparatus to perform at least a method. The method may include receiving, from a serving cell, at least one radio resource control configuration or device capability report signal associated with at least one multi-reception chain user equipment mode. The method may further include transmitting, to the serving cell, an indication that at least one multi-reception chain user equipment mode is preferred. The method may further include, in response to transmitting the indication that at least one multi-reception chain user equipment mode is preferred, receiving, from the serving cell, an indication that the at least one preferred multi-reception chain user equipment mode is in operation.

In accordance with some example embodiments, a computer program product may perform a method. The method may include receiving, from a serving cell, at least one radio resource control configuration or device capability report signal associated with at least one multi-reception chain user equipment mode. The method may further include transmitting, to the serving cell, an indication that at least one multi-reception chain user equipment mode is preferred. The method may further include, in response to transmitting the indication that at least one multi-reception chain user equipment mode is preferred, receiving, from the serving cell, an indication that the at least one preferred multi-reception chain user equipment mode is in operation.

In accordance with certain example embodiments, an apparatus may include at least one processor and at least one memory storing instructions that, when executed by the at least one processor, cause the apparatus at least to receive, from a serving cell, at least one radio resource control configuration or device capability report signal associated with at least one multi-reception chain user equipment mode. The at least one memory and instructions, when executed by the at least one processor, may further cause the apparatus at least to transmit, to the serving cell, an indication that at least one multi-reception chain user equipment mode is preferred. The at least one memory and instructions, when executed by the at least one processor, may further cause the apparatus at least to, in response to transmitting the indication that at least one multi-reception chain user equipment mode is preferred, receive, from the serving cell, an indication that the at least one preferred multi-reception chain user equipment mode is in operation.

In accordance with various example embodiments, an apparatus may include receiving circuitry configured to perform receiving, from a serving cell, at least one radio resource control configuration or device capability report signal associated with at least one multi-reception chain user equipment mode. The apparatus may further include transmitting circuitry configured to perform transmitting, to the serving cell, an indication that at least one multi-reception chain user equipment mode is preferred. The apparatus may further include receiving circuitry configured to perform in response to receiving the indication that at least one multi-reception chain user equipment mode is preferred, receiving, from the serving cell, an indication that the at least one preferred multi-reception chain user equipment mode is in operation.

In accordance with some example embodiments, a method may include transmitting, to a user equipment, at least one radio resource control configuration associated with at least one multi-receiver chain user equipment mode. The method may further include receiving, from the user equipment, an indication that at least one multi-receiver chain user equipment mode is preferred. The method may further include, in response to receiving the indication that at least one multi-receiver chain user equipment mode is preferred, transmitting, to the user equipment, an indication that the at least one preferred multi-receiver chain user equipment mode is in operation.

In accordance with certain example embodiments, an apparatus may include means for transmitting, to a user equipment, at least one radio resource control configuration associated with at least one multi-receiver chain user equipment mode. The apparatus may further include means for receiving, from the user equipment, an indication that at least one multi-receiver chain user equipment mode is preferred. The apparatus may further include means for, in response to receiving the indication that at least one multi-receiver chain user equipment mode is preferred, transmitting, to the user equipment, an indication that the at least one preferred multi-receiver chain user equipment mode is in operation.

In accordance with various example embodiments, a non-transitory computer readable medium comprising program instructions that, when executed by an apparatus, cause the apparatus to perform at least a method. The method may include transmitting, to a user equipment, at least one radio resource control configuration associated with at least one multi-receiver chain user equipment mode. The method may further include receiving, from the user equipment, an indication that at least one multi-receiver chain user equipment mode is preferred. The method may further include in response to receiving the indication that at least one multi-receiver chain user equipment mode is preferred, transmitting, to the user equipment, an indication that the at least one preferred multi-receiver chain user equipment mode is in operation.

In accordance with some example embodiments, a computer program product may perform a method. The method may include transmitting, to a user equipment, at least one radio resource control configuration associated with at least one multi-receiver chain user equipment mode. The method may further include receiving, from the user equipment, an indication that at least one multi-receiver chain user equipment mode is preferred. The method may further include in response to receiving the indication that at least one multi-receiver chain user equipment mode is preferred, transmitting, to the user equipment, an indication that the at least one preferred multi-receiver chain user equipment mode is in operation.

In accordance with certain example embodiments, an apparatus may include at least one processor and at least one memory storing instructions that, when executed by the at least one processor, cause the apparatus at least to transmit, to a user equipment, at least one radio resource control configuration associated with at least one multi-receiver chain user equipment mode. The at least one memory and instructions, when executed by the at least one processor, may further cause the apparatus at least to receive, from the user equipment, an indication that at least one multi-receiver chain user equipment mode is preferred. The at least one memory and instructions, when executed by the at least one processor, may further cause the apparatus at least to, in response to receiving the indication that at least one multi-receiver chain user equipment mode is preferred, transmit, to the user equipment, an indication that the at least one preferred multi-receiver chain user equipment mode is in operation.

In accordance with various example embodiments, an apparatus may include transmitting circuitry configured to perform transmitting, to a user equipment, at least one radio resource control configuration associated with at least one multi-receiver chain user equipment mode. The apparatus may further include receiving circuitry configured to perform receiving, from the user equipment, an indication that at least one multi-receiver chain user equipment mode is preferred. The apparatus may further include transmitting circuitry configured to perform, in response to receiving the indication that at least one multi-receiver chain user equipment mode is preferred, transmitting, to the user equipment, an indication that the at least one preferred multi-receiver chain user equipment mode is in operation.

### BRIEF DESCRIPTION OF THE DRAWINGS

For a proper understanding of example embodiments, reference should be made to the accompanying drawings, wherein:

FIG. 1 illustrates an example of a single Rx chain UE operation.

FIG. 2 illustrates an example of a multi-Rx chain UE.

FIG. 3 illustrates an example of several potential receiving modes for multi-Rx capable UE beams.

FIG. 4 illustrates an example of a signaling diagram according to certain example embodiments.

FIG. 5 illustrates an example of a signaling diagram showing data transmissions and measurement gaps/scheduling restrictions during measurements according to some example embodiments.

FIG. 6 illustrates an example of a signaling diagram showing data transmissions with simultaneous measurements according to various example embodiments.

FIG. 7 illustrates an example of a signaling diagram showing data transmissions and interruptions during measurements according to certain example embodiments.

FIG. 8 illustrates an example of UE-initiated mode adaptation according to some example embodiments.

FIG. 9 illustrates an example of RRC-based implementation of UE triggered mode changes according to various example embodiments.

FIG. 10 illustrates an example of certain network devices according to some example embodiments.

FIG. 11 illustrates an example of a 5G network and system architecture according to some example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for multi-Rx chain UEs is not intended to limit the scope of certain example embodiments, but is instead representative of selected example embodiments.

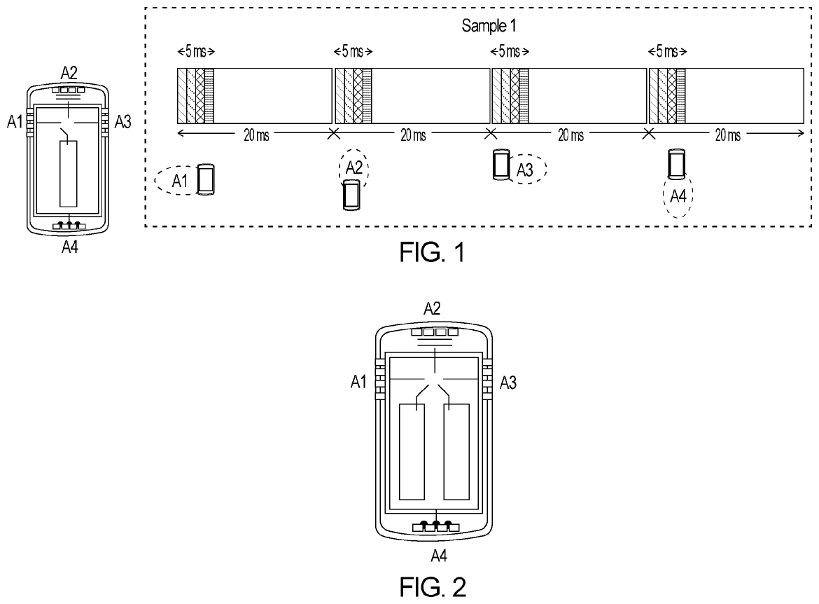

Frequency range (FR) 2 arrays on UE may be directive; thus, in order to perform satisfactorily, UEs are embedded with multiple antenna panels. However, the number of antenna panels and Rx chains on the UE may not be mapped 1-to-1. 3GPP includes requirements for single-chain UE, wherein these UE may only activate a single FR2 panel at a time. This limitation has some drawbacks with neighbor cell measurements since the UE needs to sweep its panels one at a time in order to fully understand its environment. This is depicted in FIG. 1, wherein a single-chain 4-panel UE may require 4 consecutive bursts for a single sample acquisition. In addition, 3-5 samples may be needed for each Rx spatial setting for L1 or L3 measurements to ensure measurement accuracy.

FIG. 2 illustrates an example of a possible multi-Rx chain UE implementation, which may improve performance of the UE and system, including measurement related latencies. As shown in FIG. 2, the UE may be implemented with 4 antenna panels arranged to improve spherical coverage, and 2 Rx chains are used. The two Rx chains shown may be switched among the four panels, such that any combination of two panels may be active simultaneously.

One challenge with legacy FR2 UE is measurement latency due to UE Rx scheduling restrictions. A legacy FR2 UE may have Rx restriction conditions to perform a single task of reception among L3 measurements (cell search), L1 measurement (beam measurement and management), monitoring of PDCCH, demodulation of PDSCH, and CSI measurements. Some example embodiments discussed herein may resolve some of these challenges with FR2 by using multi-Rx chains.

The network may consider Rx capabilities of a UE, and check Rx scheduling availability to schedule a specific signal reception task from a single cell or multiple cells/TRPs. UE RX scheduling restrictions may cause significant latency to conduct multiple tasks, including if the signal for the tasks overlap or are adjacent over time. While a UE receives signals from gNBs requiring some of the listed tasks, a legacy UE capability may be limited to perform one task at a time.

SSBs associated with different PCIs overlapping may include 2 cases. In a first case, SSBs associated to the cell with PCI different from serving cell may be used for L1-RSRP measurements, and SSBs configured for serving cell L1 measurements (i.e., L1-RSRP, L1-SINR, RLM, BFR) may overlap. In a second case, SSBs associated to the cell with PCI different from serving cell may be used for L1-RSRP measurements, and SSBs for the serving cell L3 measurements (i.e., SSBs in SMTC) may overlap.

For case 1 in FR2, RRM requirements may assume that the UE performs L1-RSRP measurements for one cell at a time. For case 2 in FR2, if all SSB measurement occasions of the cell with PCI are different from the serving cell, and SMTC fully overlap, RRM requirements may not be specified. For case 2 in FR2, if all SSB measurement occasions of the cell with PCI different from serving cell and SMTC are partially overlapped, i.e., SSB periodicity of the cell with different PCI <SMTC periodicity, RRM requirements are specified assuming UE performs L1 measurements on the SSB occasions of the cell with PCI different from serving cell that are not overlapped with SMTC.

Regarding explicit differences between FR1 and FR2 UEs, a FRI UE can perform most Rx receptions from multiple cells, while a FR2 UE may require that the network allows enough of a time period to conduct all tasks one by one, and repeatedly transmit messages or reference signals to schedule a UE to finish the allocated tasks. FR2 UE RX scheduling restrictions may be due to RX beam steering restrictions. Since FR2 UEs may use a single Rx chain, and since analog beamforming may be assumed at FR2, UEs are unable to monitor multiple beams simultaneously. As a result, while the UEs perform beam sweeping during L1/L3 measurements, the UEs cannot monitor or demodulate the signals from the serving beam used for PDCCH and PDSCH.

Certain example embodiments described herein may have various benefits and/or advantages to overcome the disadvantages described above. For example, certain example embodiments may improve power consumption and reduce latency by processing multiple receptions and tasks. Power may also be saved by turning off some or RX chains. Thus, certain example embodiments discussed below are directed to improvements in computer-related technology.

Some example embodiments discussed below may include various UE processing modes and indications per Rx chain, where the network may control a UE with multiple Rx chains. As discussed above, FIG. 2 depicts a multi-Rx chain UE in a handset, which can enable the same or different tasks across Rx chains. UE tasks may include, for example, RRM, demodulation, and CSI as L3 measurements (cell search), L1 measurements (beam measurement and management), PDCCH monitoring, demodulation of PDSCH, and CSI measurements. Various example embodiments may relate to 3 modes of operation for multi-chain UEs, as well as the network controlling activation/de-activation of these modes, each of these modes discussed below.

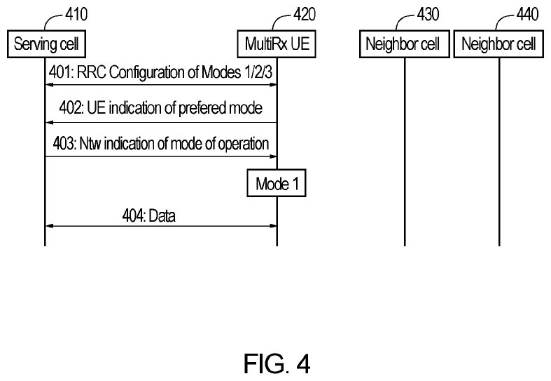

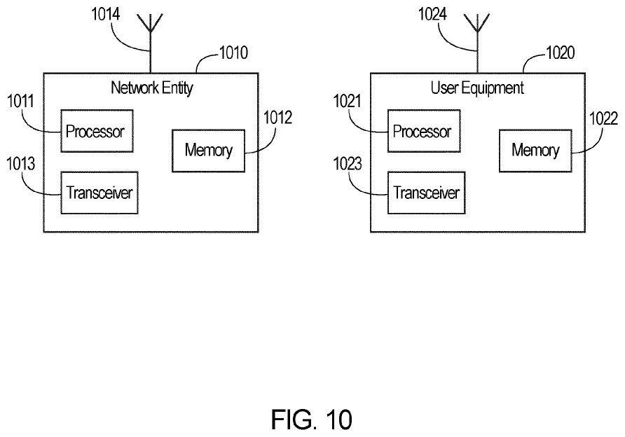

FIG. 4 illustrates an example of a signaling diagram depicting single chain reception to save power at the UE or for using additional Rx chains for multi-USIM purposes. Neighbor cells 430 and 440, and serving cell 410, may be similar to NE 1010, while UE 420 may be similar to UE 1020, as illustrated in FIG. 10, according to certain example embodiments.

At 401, serving cell 410 and UE 420 may exchange RRC configurations related to any combination of a first, second, and third mode.

At 402, in response to receiving the configurations at 401, UE 420 may indicate to serving cell 410 a preferred mode corresponding with the first, second, or third mode.

At 403, serving cell 410 may transmit an indication to UE 420 of a mode of operation. For example, the modes of operation may include be switched by network signalling (e.g., RRC, MAC, DCI) and/or UE implementation. In response to the indication at 403, UE 420 may enter the preferred mode; as an example, FIG. 4 depicts UE 420 entering the first mode.

At 404, serving cell 410 and UE 420 may exchange data according to the preferred mode. A period of time for performing measurements may then begin.

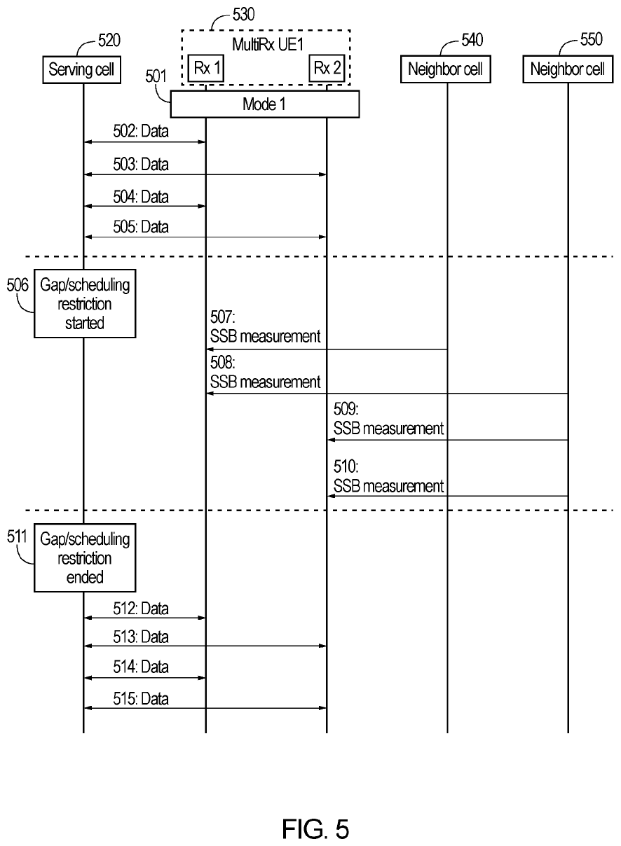

FIG. 5 illustrates an example of a signaling diagram depicting a mode for data transmissions and measurement gaps/scheduling restrictions during measurements. Neighbor cells 540 and 550, and serving cell 520, may be similar to NE 1010, while UE 530 may be similar to UE 1020, as illustrated in FIG. 10, according to certain example embodiments. The mode shown in FIG. 5 may be suitable for power saving when such high performance or latency reduction are not required.

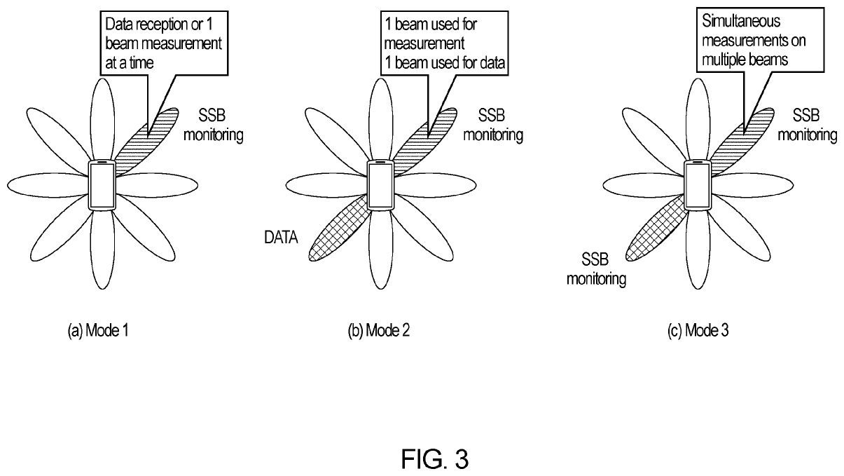

As shown in FIG. 3(a), UE 530 may not be required to perform measurements of neighbor cells 540 and 550, nor transmit data simultaneously. Measurement gaps, interruptions, or scheduling restrictions may apply during measurements. Even for multi-Rx capable UEs, this embodiment may have advantages when UE 530 does not want to have all of its Rx activated, for example, to conserve power and/or because UE 530 is monitoring other networks in a multi-universal subscriber identity module (MUSIM).

At 501, UE 530 may enter and be operating in a first mode.

At 502, serving cell 520 may exchange data with a first Rx chain of UE 530, while at 503, serving cell 520 may exchange data with a second Rx chain of UE 530.

At 504, serving cell 520 may exchange data with the first Rx chain of UE 530, while at 505, serving cell 520 may exchange data with the second Rx chain of UE 530.

At 506, serving cell 520 may start gap/scheduling restrictions.

At 507, neighbor cell 540 may perform SSB measurements on the first Rx chain of UE 530, while at 508, neighbor cell 550 may perform SSB measurements on the first Rx chain of UE 530.

At 509, neighbor cell 540 may perform SSB measurements on the first Rx chain of UE 530, while at 510, neighbor cell 550 may transmit SSB measurements to the first Rx chain of UE 530.

At 511, serving cell 520 may stop the gap/scheduling restrictions started at 506.

At 512, serving cell 520 may exchange data with the first Rx chain of UE 530, while at 513, serving cell 520 may exchange data with the second Rx chain of UE 530.

At 514, serving cell 520 may exchange data with the first Rx chain of UE 530, while at 515, serving cell 520 may exchange data with the second Rx chain of UE 530.

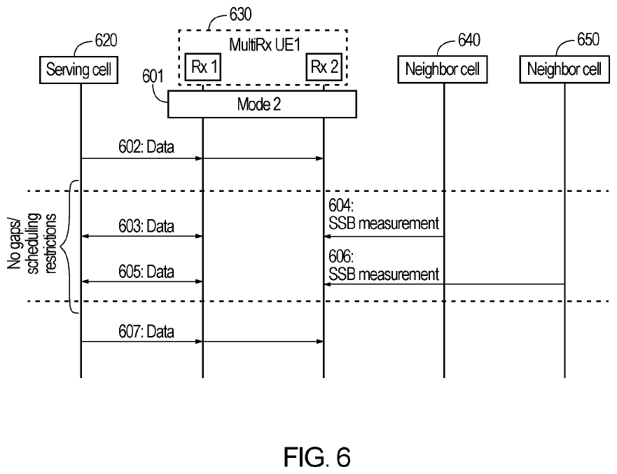

FIG. 6 illustrates an example of a signaling diagram depicting data transmissions with simultaneous measurements without gap/scheduling restrictions. Neighbor cells 640 and 650, and serving cell 620 may be similar to NE 1010, while UE 630 may be similar to UE 1020, as illustrated in FIG. 10, according to certain example embodiments. UE 630 may be capable of receiving data signals from serving cell 620, which may at least partially overlap in time with reference signals (e.g. SSB) received from neighbor cells 640 and 650.

As illustrated in FIG. 3(b) and FIG. 6, simultaneous data reception and measurements may be expected. This mode may reduce the impact of the measurements over user data throughput and latency. Since scheduling restrictions can avoided or minimized using this mode, serving cell 620 may have more freedom for its scheduler, and better network efficiency can be achieved. Some embodiments may have the advantage of not requiring Rx scheduling restrictions. Latency reductions can be reduced by simultaneous scheduling of different resources from multiple cells.

In various example embodiments, multi-chain Rx may be used for simultaneous data or reference signal reception from serving cell 620 or neighbor cells 640 and 650. Multiple RX chains may be enabled, and each Rx chain may perform a different task of the task list simultaneously. Some Rx chains steered to a cell may conduct one or more tasks, while some Rx chains steered to another cell may conduct other tasks (for example, L3 measurements (cell search), L1 measurement (beam measurement and management), monitoring of PDCCH, demodulation of PDSCH, and CSI measurements). In some example embodiments, one Rx chain may be assigned to process PDSCH from neighbor cell 640, while another Rx chain may be assigned to process RRM measurement from neighbor cell 650.

At 601, UE 630 may enter and be operating in a second mode.

At 602, serving cell 620 may exchange data with a first Rx chain of UE 630 and a second Rx chain of UE 630.

At 603, serving cell 620 may exchange data with the first Rx chain of UE 630, while simultaneously, at 604, UE 630 may perform SSB measurements on the second Rx chain of UE 630 (for example, L3 measurements (cell search), L1 measurement (beam measurement and management), monitoring of PDCCH, demodulation of PDSCH, and CSI measurements), which at least partially overlap with the data exchanged at 603.

At 605, serving cell 620 may exchange data with the first Rx chain of UE 630, while simultaneously, at 606, UE 630 may perform SSB measurements on the second Rx chain of UE 630 (for example, L3 measurements (cell search), L1 measurement (beam measurement and management), monitoring of PDCCH, demodulation of PDSCH, and CSI measurements), which at least partially overlap with the data exchanged at 605.

At 607, serving cell 620 may exchange data with a first Rx chain of UE 630 and a second Rx chain of UE 630.

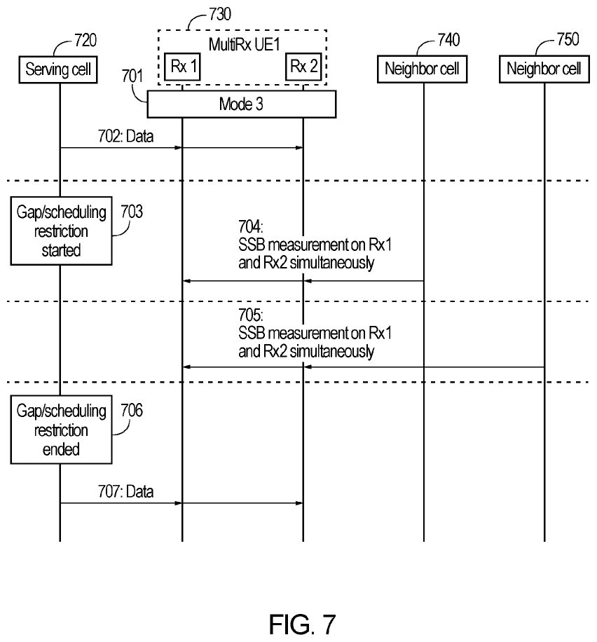

FIG. 7 illustrates an example of a signaling diagram depicting data transmissions and interruptions during measurements. Neighbor cells 740 and 750, and serving cell 720 may be similar to NE 1010, while UE 730 may be similar to UE 1020, as illustrated in FIG. 10, according to certain example embodiments.

In various example embodiments, multi-chain reception may be used, for example, for latency reduction and faster UE Rx processing or Rx with high performance. Multiple Rx chains may be enabled by the network or UE implementation, where the multiple Rx chains may perform the same task simultaneously (e.g., L3 measurements (cell search), L1 measurement (beam measurement and management), monitoring of PDCCH, demodulation of PDSCH, and CSI measurements). Specifically, Rx chains may perform RRM measurements or both Rx chains may perform PDSCH decoding. Multiple RX chains may be assigned to measure L1-RSRP from a cell at the same time for beam sweeping time reduction. In addition, multiple Rx chains may be assigned to measure RRM measurements of L1-RSRP and L3-RSRP at the same time using a narrow beam and a wide beam, respectively. Multiple RX chains may also be assigned to PDSCH/PDCCH from at least one cell to effectively achieve MIMO spatial multiplexing gains. Various example embodiments may provide fast processing or high performance by doing the same task on multiple Rx chains. UE 730 can enjoy the benefits of fast beam sweeping using multiple RX panel or higher MIMO layer configuration using multiple RX panels.

Some example embodiments may have the advantage of fast processing or high performance by doing the same task on multiple Rx chains. UE 730 may enjoy the benefits of fast beam sweeping using multiple RX panel or higher MIMO layer configuration using multiple RX panels.

FIGS. 3(c) and 7 depict a UE using its capability to receive with multiple receiver chains to perform measurements in multiple beams simultaneously. A beam sweeping scaling factor of 8 may be used, and RRM measurements and procedures may be scaled by this factor for FR2-1 requirements. When using this mode, the UE may perform single measurements faster, wherein the period measurements can be performed more often, leading to more reliable measurements for mobility. These measurements can also be performed with the same periodicity, which would mean that the number of measurement occasions with interruptions and scheduling restrictions would be reduced and better network efficiency can be achieved. In addition, for some RRM requirements, a large scaling factor may imply that when the UE finishes a measurement, it may already have moved in a way that would render the measurement not valid anymore. Thus, reduction of beam sweeping scaling factor may render measurements more robust to mobility.

At 701, UE 730 may enter and be operating in a third mode.

At 702, serving cell 720 may exchange data with a first Rx chain of UE 730 and a second Rx chain of UE 730 simultaneously.

At 703, serving cell 720 may start gap/scheduling restrictions.

At 704, UE 730 may perform measurements (e.g., SSB) from a first direction based on SSB signals from neighbor cell 740 with the first Rx chain of UE 730, while simultaneously, UE 730 may perform measurements (e.g., SSB) from a second direction based on SSB signals from neighbor cell 740 (or another cell) with SSB signals at least partially overlapping with the signals in 704 with the second Rx chain of UE 730.

At 705, UE 730 may perform measurements (e.g., SSB) from a first direction based on SSB signals from neighbor cell 750 with the first Rx chain of UE 730, while simultaneously, UE 730 may perform measurements (e.g., SSB) from a second direction based on SSB signals from neighbor cell 750 (or another cell) with SSB signals at least partially overlapping with the signals in 705 with the second Rx chain of UE 730.

At 706, serving cell 720 may stop the gap/scheduling restrictions.

At 707, serving cell 720 may exchange data with a first Rx chain of UE 730 and a second Rx chain of UE 730.

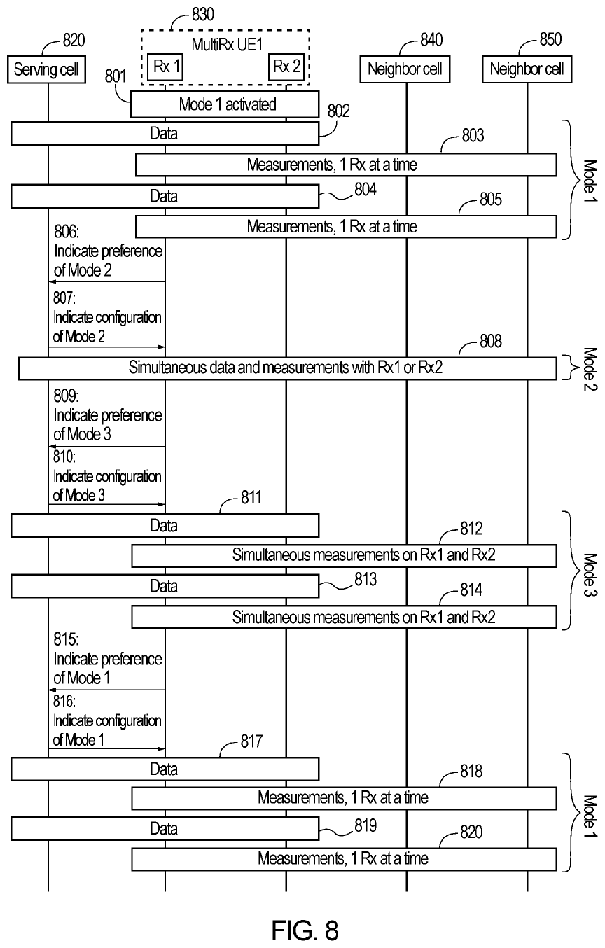

FIG. 8 illustrates an example of a signaling diagram depicting a UE-initiated mode adaptation. Neighbor cells 850 and 860, and serving cell 830 may be similar to NE 1010, while UE 840 may be similar to UE 1020, as illustrated in FIG. 10, according to certain example embodiments.

FIG. 8 depicts various embodiments where a UE may initiate the adaptation of the receiving mode. The network may have configured Mode 1 as default at UE 830. UE 830 may trigger this procedure by sending a message with the preferred mode, and NE 820 responds either confirming the change in the receiving mode or by maintaining it or falling back to a default mode configuration. If at some moment of time UE 830 starts an application demanding high throughput and low latency, UE 830 may request the network to change the receive mode to Mode 2. If at some moment UE 830 detects a high mobility state, UE 830 may trigger the mode change to Mode 3, and assure that mobility measurements are more accurate. Likewise, if UE 830 is in a more power demanding Mode 2 or Mode 3 and needs to save power, UE 830 may fallback to Mode 1.

In some embodiments, UE 830 may determine applications with high throughput/high mobility/need for power saving, for example, when UE 830 identifies that a battery level is low, UE 830 may activate Mode 1 to save battery power. Alternatively, UE 830 may identify an increase in data traffic with demanding QoS demands, UE 830 may start Mode 2 or Mode 3 to increase throughput by using simultaneous reception on Rx1 and Rx2. In addition, if UE 830 identifies that data traffic with low latency demands is started, UE 830 may activate Mode 2 in order to avoid measurement gaps and reduce jitter in data transmission. Furthermore, if UE 830 identifies that it is moving above a certain speed, UE 830 may activate mode 3 so that it can make better mobility decisions.

FIG. 8 depicts example embodiments where the network configured the same mode as requested by UE 830. However, there might be situations where the network can't configure UE 830 as requested. For this situation, a fallback state may be assigned, which can be either a configured state by the network, for example Mode 3, or the implemented method in the standard can also have a single default mode, for example Mode 1.

At 801, UE 840 may activate a first mode, which may be configured as a default mode.

At 802, serving cell 830 may exchange data with a first Rx chain of UE 840 and a second Rx chain of UE 840 simultaneously.

At 803, neighbor cells 850 and 860 may separately (in series) perform measurements on the first Rx chain of UE 840 and the second Rx chain of UE 840 in accordance with the first mode.

At 804, serving cell 830 may exchange data with the first Rx chain of UE 840 and the second Rx chain of UE 840 simultaneously in accordance with the first mode.

At 805, neighbor cells 850 and 860 may separately (in series) perform measurements on the first Rx chain of UE 840 and the second Rx chain of UE 840 in accordance with the first mode.

At 806, UE 840 may transmit an indication to serving cell 830 of a preference for a second mode. In various example embodiments, the second mode may require fewer or no scheduling restrictions, thereby improving latency.

At 807, serving cell 830 may transmit a configuration of the second mode to the first Rx chain of UE 840.

At 808, serving cell 830, neighbor cell 850, and neighbor cell 860 may simultaneously exchange data with the first and second Rx chain of UE 840, and perform measurements on the first and second Rx chain of UE 840

At 809, UE 840 may transmit an indication to serving cell 830 of a preference for a third mode. In various example embodiments, UE 840 may prefer the third mode if faster measurements are needed due to extremely high mobility of UE 840.

At 810, serving cell 830 may transmit a configuration of the third mode to the first Rx chain of UE 840.

At 810, serving cell 830 and the first and second Rx chain of UE 840 may exchange data.

At 811, serving cell 830, neighbor cell 850, and neighbor cell 860 may simultaneously exchange data with the first and second Rx chain of UE 840, and perform measurements on the first and second Rx chain of UE 840.

At 812, serving cell 830 and the first and second Rx chain of UE 840 may exchange data.

At 813, serving cell 830, neighbor cell 850, and neighbor cell 860 may simultaneously exchange data with the first and second Rx chain of UE 840, and perform measurements on the first and second Rx chain of UE 840.

At 814, UE 840 may transmit an indication to serving cell 830 of a preference for the first mode. In various example embodiments, UE 840 may prefer the first mode if UE 840 needs to turn off one Rx faster to conserve power.

At 815, serving cell 830 may transmit a configuration of the first mode to the first Rx chain of UE 840.

At 816, serving cell 830 and the first and second Rx chain of UE 840 may exchange data according the first mode.

At 817, serving cell 830, neighbor cell 850, and neighbor cell 860 may simultaneously exchange data with the first and second Rx chain of UE 840, and perform measurements on the first and second Rx chain of UE 840 according the first mode.

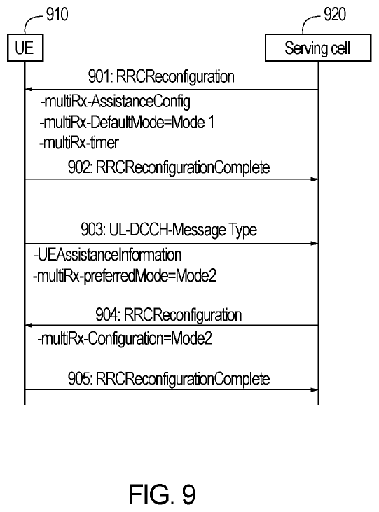

FIG. 9 illustrates an example of a signaling diagram depicting a RRC-based implementation of UE triggered mode change. Serving cell 920 may be similar to NE 1010, while UE 910 may be similar to UE 1020, as illustrated in FIG. 10, according to certain example embodiments.

In particular, FIG. 9 illustrates an embodiment based on RRC signalling. Serving cell 920 may indicate the multiRx-AssistanceConfig in order to indicate to UE 910 that adaptation of multi Rx chain is enabled by serving cell 920 and to configure the relevant parameters for UE 910 to use while adapting each multi Rx mode. This indication is shown in the RRCReconfiguration message. Additionally, serving cell 920 may indicate which is the default multi Rx mode to be used by UE 910. In order to signal the network configuration, new information elements may be defined in the RRCReconfiguration message such as multiRx-AssistanceConfig, multiRx-DefaultMode with the default mode for the multi Rx chain, and multiRx-timer.

At 901, serving cell 920 may transmit to UE 910 an RRCReconfiguration message, which may include multiRx-Assistance Config, multiRx-DefaultMode=Mode1, and multiRx-timer. As an example, multiRx-timer may be used to prevent UE 910 from requesting changes too often; thus, the modes may be active at least for the duration of multiRx-timer.

At 902, UE 910 may transmit to serving cell 920 a RRCReconfigurationComplete message.

At 903, UE 910 may transmit to serving cell 920 a UL-DCCH-MessageType message, which may include UEAssistanceInformation and multiRx-preferredMode=Mode2. After the RRCReconfiguration is complete, UE 910 may indicate to serving cell 920 its preferred multi Rx mode using UEAssistance information. A new UEAssistance information element may be included to indicate the UE preferred mode, multiRx-preferredMode

At 904, serving cell 920 may transmit to UE 910 an RRCReconfiguration message, which may include multiRx-Configuration=Mode2.

At 905, UE 910 may transmit to serving cell 920 an RRCReconfigurationComplete message.

FIG. 10 illustrates an example of a system according to certain example embodiments. In one example embodiment, a system may include multiple devices, such as, for example, NE 1010 and/or UE 1020.

NE 1010 may be one or more of a base station, such as an eNB or gNB, a serving gateway, a server, and/or any other access node or combination thereof.

NE 1010 may further comprise at least one gNB-CU, which may be associated with at least one gNB-DU. The at least one gNB-CU and the at least one gNB-DU may be in communication via at least one F1 interface, at least one Xn-C interface, and/or at least one NG interface via a 5GC.

UE 1020 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 1010 and/or UE 1020 may be one or more of a citizens broadband radio service device (CBSD).

NE 1010 and/or UE 1020 may include at least one processor, respectively indicated as 1011 and 1021. Processors 1011 and 1021 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 1012 and 1022. The memory may be fixed or removable. The memory may include computer program instructions or computer code contained therein. Memories 1012 and 1022 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., RAM vs. ROM). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 1011 and 1021, memories 1012 and 1022, and any subset thereof, may be configured to provide means corresponding to the various blocks of FIGS. 4-9. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 10, transceivers 1013 and 1023 may be provided, and one or more devices may also include at least one antenna, respectively illustrated as 1014 and 1024. The device may have many antennas, such as an array of antennas configured for multiple input multiple output (MIMO) communications, or multiple antennas for multiple RATs. Other configurations of these devices, for example, may be provided. Transceivers 1013 and 1023 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 4-9). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 4-9. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

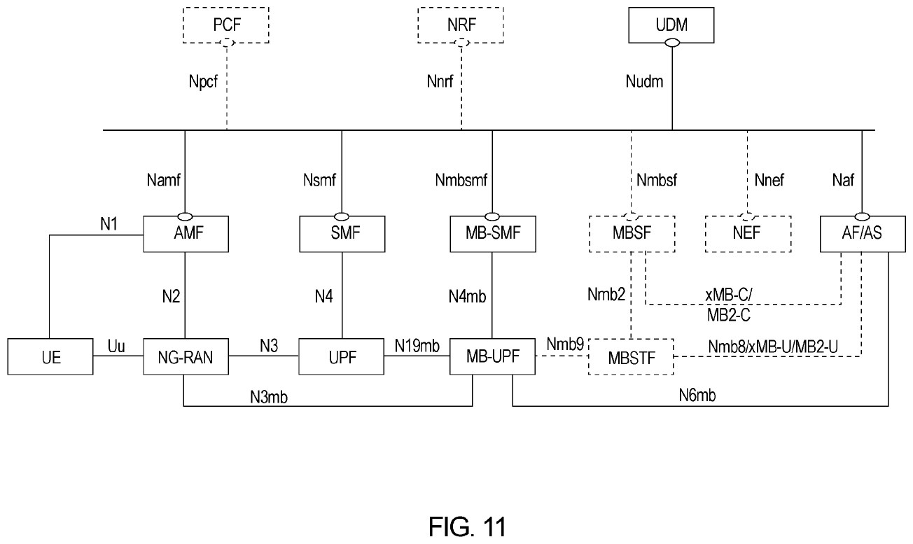

FIG. 11 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 11 may be similar to NE 1010 and UE 1020, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

According to certain example embodiments, processors 1011 and 1021, and memories 1012 and 1022, may be included in or may form a part of processing circuitry or control circuitry. In addition, in some example embodiments, transceivers 1013 and 1023 may be included in or may form a part of transceiving circuitry.

In some example embodiments, an apparatus (e.g., NE 1010 and/or UE 1020) may include means for performing a method, a process, or any of the variants discussed herein. Examples of the means may include one or more processors, memory, controllers, transmitters, receivers, and/or computer program code for causing the performance of the operations.

In various example embodiments, apparatus 1020 may be controlled by memory 1022 and processor 1021 to receive, from a serving cell, at least one radio resource control configuration or device capability report signal associated with at least one multi-reception chain user equipment mode; transmit, to the serving cell, an indication that at least one multi-reception chain user equipment mode is preferred; and, in response to transmitting the indication that at least one multi-reception chain user equipment mode is preferred, receive, from the serving cell, an indication that the at least one preferred multi-reception chain user equipment mode is in operation.

Certain example embodiments may be directed to an apparatus that includes means for performing any of the methods described herein including, for example, means for means for receiving, from a serving cell, at least one radio resource control configuration or device capability report signal associated with at least one multi-reception chain user equipment mode; means for transmitting, to the serving cell, an indication that at least one multi-reception chain user equipment mode is preferred; and means for in response to transmitting the indication that at least one multi-reception chain user equipment mode is preferred, receiving, from the serving cell, an indication that the at least one preferred multi-reception chain user equipment mode is in operation.

In various example embodiments, apparatus 1010 may be controlled by memory 1012 and processor 1011 to transmit, to a user equipment, at least one radio resource control configuration associated with at least one multi-receiver chain user equipment mode; receive, from the user equipment, an indication that at least one multi-receiver chain user equipment mode is preferred; and in response to receiving the indication that at least one multi-receiver chain user equipment mode is preferred, transmit, to the user equipment, an indication that the at least one preferred multi-receiver chain user equipment mode is in operation

Certain example embodiments may be directed to an apparatus that includes means for performing any of the methods described herein including, for example, means for receiving, from a serving cell, at least one radio resource control configuration or device capability report signal associated with at least one multi-reception chain user equipment mode; means for transmitting, to the serving cell, an indication that at least one multi-reception chain user equipment mode is preferred; and means for receiving, in response to transmitting the indication that at least one multi-reception chain user equipment mode is preferred, from the serving cell, an indication that the at least one preferred multi-reception chain user equipment mode is in operation.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

Partial Glossary

| | |
|---|---|
| 3GPP | Third Generation Partnership Project |
| 5G | Fifth Generation |
| 5GC | Fifth Generation Core |
| 5GS | Fifth Generation System |
| 6G | Sixth Generation |
| AMF | Access and Mobility Management Function |
| ASIC | Application Specific Integrated Circuit |
| BS | Base Station |
| CAPC | Channel Access Priority Class |
| CBSD | Citizens Broadband Radio Service Device |
| CN | Core Network |
| CPU | Central Processing Unit |
| CSI | Channel State Information |
| DCI | Downlink Control Information |
| DL | Downlink |
| eMBB | Enhanced Mobile Broadband |
| eMTC | Enhanced Machine Type Communication |
| eNB | Evolved Node B |
| EPS | Evolved Packet System |
| FR | Frequency Range |
| gNB | Next Generation Node B |
| GPS | Global Positioning System |
| HDD | Hard Disk Drive |
| L1 | Layer 1 |
| L2 | Layer 2 |
| LTE | Long-Term Evolution |
| LTE-A | Long-Term Evolution Advanced |
| MAC | Medium Access Control |
| MBS | Multicast and Broadcast Systems |
| MC | Multicast |
| MCS | Modulation and Coding Scheme |
| MEMS | Micro Electrical Mechanical System |
| MIB | Master Information Block |
| MIMO | Multiple Input Multiple Output |
| MME | Mobility Management Entity |
| mMTC | Massive Machine Type Communication |
| MPDCCH | Machine Type Communication Physical Downlink |
| | Control Channel |
| MTC | Machine Type Communication |
| NAS | Non-Access Stratum |
| NB-IoT | Narrowband Internet of Things |
| NE | Network Entity |
| NG | Next Generation |
| NG-eNB | Next Generation Evolved Node B |
| NG-RAN | Next Generation Radio Access Network |
| NR | New Radio |
| NR-U | New Radio Unlicensed |
| OFDM | Orthogonal Frequency Division Multiplexing |
| PDA | Personal Digital Assistance |
| PDCCH | Physical Downlink Control Channel |
| PDSCH | Physical Downlink Shared Channel |
| PRB | Physical Resource Block |
| RAM | Random Access Memory |
| RAN | Radio Access Network |
| RAT | Radio Access Technology |
| RE | Resource Element |
| RLC | Radio Link Control |
| RRC | Radio Resource Control |
| RRM | |
| RS | Reference Signal |
| RSRP | Reference Signal Received Power |
| SDU | Service Data Unit |
| SMF | Session Management Function |
| SMTC | Synchronization Signal/Physical Broadcast |
| | Block Measurement Timing Configuration |
| SR | Scheduling Report |
| SRB | Signaling Radio Bearer |
| SSB | Synchronization Signal Block |
| TB | Transport Block |
| Tx | Transmission |
| UE | User Equipment |
| UL | Uplink |
| UMTS | Universal Mobile Telecommunications System |
| UPF | User Plane Function |
| URLLC | Ultra-Reliable and Low-Latency Communication |
| UTRAN | Universal Mobile Telecommunications System |
| | Terrestrial Radio Access Network |
| WLAN | Wireless Local Area Network |

We claim:

1. A method comprising:
receiving, from a serving cell, at least one radio resource control configuration or device capability report signal associated with at least one multi-reception chain user equipment mode;
transmitting, to the serving cell, an indication that at least one multi-reception chain user equipment mode is preferred; and
in response to transmitting the indication that at least one multi-reception chain user equipment mode is preferred, receiving, from the serving cell, an indication that the at least one preferred multi-reception chain user equipment mode is in operation.

2. The method of claim 1, further comprising:
receiving, from the serving cell, data according to the at least one preferred multi-receiver chain user equipment mode.

3. The method of any claim 1 or 2, further comprising:
receiving, from a first cell, at least one of synchronization signal block, channel state information reference signal, physical downlink control channel, or physical downlink shared channel at a first receiver based upon the at least one preferred multi-reception chain user equipment mode; and
receiving, from the first cell, at least one of a synchronization signal block, channel state information reference signal, physical downlink control channel, or physical downlink shared channel at a second receiver simultaneously with the at least one synchronization signal block measurement received at the first receiver based upon the at least one preferred multi-reception chain user equipment mode.

4. The method of any of claims 1-3, further comprising:
receiving, from a first cell, at least one of a synchronization signal block, channel state information reference signal, physical downlink control channel, or physical downlink shared channel at the first receiver based upon the at least one preferred multi-reception chain user equipment mode; and
receiving, from a second cell having a cell identifier different from the first cell, at least one of synchronization signal block, channel state information reference signal, physical downlink control channel, or physical downlink shared channel at the second receiver that at least partially overlaps in time with the at least one synchronization signal block measurement received at the first receiver based upon the at least one preferred multi-reception chain user equipment mode.

5. The method of any of claims 1-4, further comprising:
receiving one of the signals from a cell, the first receiver based upon the at least one preferred multi-reception chain user equipment mode; and
receiving, from a cell, signals at the first receiver related to an active data connection; and
measuring, from a cell, at least one synchronization signal block measurement that at least partially overlaps in time with the signals related to the data exchange on the first receiver at the second receiver simultaneously with the at least one signal received at the first receiver based upon the at least one preferred multi-reception chain user equipment mode.

6. The method of any of claims 1-5, further comprising:
performing, from a cell, at least one task of measurement on synchronization signal block, measurement on channel state information reference signal, or demodulation of physical downlink control channel or physical downlink shared channel at the first receiver and the second receiver.

7. The method of any of claims 1-5, further comprising, based upon the at least one preferred multi-reception chain user equipment mode, at least one of:
performing, from the first cell, a measurement on at least one of a: synchronization signal block, channel state information reference signal, demodulation of physical downlink control channel, or demodulation of a physical downlink shared channel at the first receiver; and
performing, from the first cell or the second cell, a measurement on at least one of a: synchronization signal block, channel state information reference signal, demodulation of physical downlink control channel, or demodulation of a physical downlink shared channel at the second receiver.

8. The method of any of claims 1-7, wherein the radio resource control configuration comprises at least one of:
an indication that mode adaptation is allowed; and
an indication of at least one allowed mode to be used.

9. A method comprising:
transmitting, to a user equipment, at least one radio resource control configuration associated with at least one multi-receiver chain user equipment mode;
receiving, from the user equipment, an indication that at least one multi-receiver chain user equipment mode is preferred; and
in response to receiving the indication that at least one multi-receiver chain user equipment mode is preferred, transmitting, to the user equipment, an indication that the at least one preferred multi-receiver chain user equipment mode is in operation.

10. The method of claim 9, further comprising:
starting at least one of a gap or scheduling restriction based upon the configured multi-receiver chain mode.

11. An apparatus comprising:
at least one processor; and
at least one memory storing instructions that, when executed by the at least one processor, cause the apparatus at least to:
receive, from a serving cell, at least one radio resource control configuration or device capability report signal associated with at least one multi-reception chain user equipment mode;
transmit, to the serving cell, an indication that at least one multi-reception chain user equipment mode is preferred; and
in response to transmitting the indication that at least one multi-reception chain user equipment mode is preferred, receive, from the serving cell, an indication that the at least one preferred multi-reception chain user equipment mode is in operation.

12. The apparatus of claim 11, wherein the at least one memory and the instructions, when executed by the at least one processor, further cause the apparatus at least to:
receiving, from the serving cell, data according to the at least one preferred multi-receiver chain user equipment mode.

13. The apparatus of any claim 11 or 12, wherein the at least one memory and the instructions, when executed by the at least one processor, further cause the apparatus at least to:
receive, from a first cell, at least one of synchronization signal block, channel state information reference signal, physical downlink control channel, or physical downlink shared channel at a first receiver based upon the at least one preferred multi-reception chain user equipment mode; and
receive, from the first cell, at least one of a synchronization signal block, channel state information reference signal, physical downlink control channel, or physical downlink shared channel at a second receiver simultaneously with the at least one synchronization signal block measurement received at the first receiver based upon the at least one preferred multi-reception chain user equipment mode.

14. The apparatus of any of claims 11-13, wherein the at least one memory and the instructions, when executed by the at least one processor, further cause the apparatus at least to:
receive, from a first cell, at least one of a synchronization signal block, channel state information reference signal, physical downlink control channel, or physical downlink shared channel at the first receiver based upon the at least one preferred multi-reception chain user equipment mode; and
receive, from a second cell having a cell identifier different from the first cell, at least one of synchronization signal block, channel state information reference signal, physical downlink control channel, or physical downlink shared channel at the second receiver that at least partially overlaps in time with the at least one synchronization signal block measurement received at the first receiver based upon the at least one preferred multi-reception chain user equipment mode.

15. The apparatus of any of claims 11-14, wherein the at least one memory and the instructions, when executed by the at least one processor, further cause the apparatus at least to:
receive one of the signals from a cell, the first receiver based upon the at least one preferred multi-reception chain user equipment mode; and
receive, from a cell, signals at the first receiver related to an active data connection; and
measure, from a cell, at least one synchronization signal block measurement that at least partially overlaps in time with the signals related to the data exchange on the first receiver at the second receiver simultaneously with the at least one signal received at the first receiver based upon the at least one preferred multi-reception chain user equipment mode.

16. The apparatus of any of claims 11-15, wherein the at least one memory and the instructions, when executed by the at least one processor, further cause the apparatus at least to:
perform, from a cell, at least one task of measurement on synchronization signal block, measurement on channel state information reference signal, or demodulation of physical downlink control channel or physical downlink shared channel at the first receiver and the second receiver.

17. The apparatus of any of claims 11-15, wherein the at least one memory and the instructions, when executed by the at least one processor, further cause the apparatus at least to, based upon the at least one preferred multi-reception chain user equipment mode, at least one of:
perform, from the first cell, a measurement on at least one of a: synchronization signal block, channel state information reference signal, demodulation of physical downlink control channel, or demodulation of a physical downlink shared channel at the first receiver; and
perform, from the first cell or the second cell, a measurement on at least one of synchronization signal block, channel state information reference signal, a: demodulation of physical downlink control channel, or demodulation of a physical downlink shared channel at the second receiver.

18. The apparatus of any of claims 11-17, wherein the radio resource control configuration comprises at least one of:
an indication that mode adaptation is allowed; and
an indication of at least one allowed mode to be used.

19. An apparatus comprising:
at least one processor; and
at least one memory storing instructions that, when executed by the at least one processor, cause the apparatus at least to:
transmit, to a user equipment, at least one radio resource control configuration associated with at least one multi-receiver chain user equipment mode;
receive, from the user equipment, an indication that at least one multi-receiver chain user equipment mode is preferred; and
in response to receiving the indication that at least one multi-receiver chain user equipment mode is preferred, transmit, to the user equipment, an indication that the at least one preferred multi-receiver chain user equipment mode is in operation.

20. The apparatus of claim 19, wherein the at least one memory and the instructions, when executed by the at least one processor, further cause the apparatus at least to:
start at least one of a gap or scheduling restriction based upon the configured multi-receiver chain mode.
